(19) United States
(12) Patent Application Publication
(10) Pub. No.: US 2026/0348717 A1
(43) Pub. Date: Nov. 5, 2026

(54) OPTICAL DEVICE FOR SELF-REFERENCED FULL-FIELD TEMPORAL OPTICAL COHERENCE TOMOGRAPHY MICROSCOPIC IMAGING, AND ASSOCIATED FACILITY AND METHOD

(71) Applicants: SORBONNE UNIVERSITE, Paris (FR); CENTRE NATIONAL DE LA RECHERCHE SCIENTIFIQUE, Paris (FR); INSTITUT NATIONAL DE LA SANTE ET DE LA RECHERCHE MEDICALE, Paris (FR); ECOLE SUPERIEURE DE PHYSIQUE ET DE CHIMIE INDUSTRIELLES DE LA VILLE DE PARIS, Paris (FR); CENTRE HOSPITALIER NATIONAL D'OPHTALMOLOGIE DES QUINZE-VINGTS, Paris (FR)

(72) Inventors: Kate GRIEVE, PARIS (FR); Olivier THOUVENIN, PARIS (FR); Tual MONFORT, PARIS (FR); Salvatore AZZOLLINI, PARIS (FR); Sacha REICHMAN, PARIS (FR)

(73) Assignees: SORBONNE UNIVERSITE, Paris (FR); CENTRE NATIONAL DE LA RECHERCHE SCIENTIFIQUE, Paris (FR); INSTITUT NATIONAL DE LA SANTE ET DE LA RECHERCHE MEDICALE, Paris (FR); ECOLE SUPERIEURE DE PHYSIQUE ET DE CHIMIE INDUSTRIELLES DE LA VILLE DE PARIS, Paris (FR); CENTRE HOSPITALIER NATIONAL D'OPHTALMOLOGIE DES QUINZE-VINGTS, Paris (FR)

(21) Appl. No.: 19/116,466

(22) PCT Filed: Sep. 29, 2022
(86) PCT No.: PCT/FR2022/000084

§ 371 Date: Mar. 28, 2025

(51) Int. Cl. G01B 9/02091; G01B 9/02056; G01B 9/04; G01N 21/47; G02B 21/00

(52) U.S. Cl. CPC G01B 9/02091; G01B 9/02057; G01B 9/04; G01N 21/4795; G02B 21/0056

(57) ABSTRACT

Optical apparatus for the full-field optical coherence tomography microscopic imaging of at least one sample, the apparatus comprising an objective for viewing the sample during operation, the device comprising a specular interface, the device thus being capable, during operation, of allowing at least one interference to be produced between at least one reference wave obtained by reflecting light emitted by a light source associated with the apparatus on the specular interface, and at least one object wave obtained by backscattering the light emitted by said source onto the sample, the specular interface being arranged with respect to the objective such that during operation the object wave passes through said specular interface as it travels between the sample and the source.

The invention relates to an optical apparatus for the optical coherence tomography microscopic imaging of at least one sample.

The invention also relates to an associated installation and method.

### BACKGROUND OF THE INVENTION

In the field of optical imaging, optical coherence tomography (OCT) makes it possible to acquire images with high precision and in particular a greater axial resolution than can be obtained with a confocal microscope.

In particular, optical coherence tomography imaging makes it possible to:
image many different components such as cellular components,
form images within a three-dimensional sample,
form images with high optical sectioning, regardless of the numerical aperture of the associated imaging system,
carry out non-invasive imaging,
form images without a marker.

Time-domain optical coherence tomography imaging involves measuring the interferometric signal between a signal from light backscattered by a sample when the sample is illuminated by a source and a reference light signal that was emitted by the same source and has propagated over the same optical distance.

Full-field optical coherence tomography imaging makes it possible to parallelise this principle so that the interferometric signal reaches a camera-like sensor (CMOS, CDD, etc.) in order to obtain a two-dimensional image as the output.

Document FR 2 817 030 describes an example full-field optical coherence interferential microscopic imaging system.

There are two major branches of full-field optical coherence tomography imaging:
static full-field optical coherence tomography imaging (static FFOCT)—that is, “static” imaging based on different approaches for isolating the interferometric signal between the reference field and the sample field;
dynamic full-field time-domain optical coherence tomography imaging (D-FFOCT), which is based on the analysis over time of the signal generated by static FFOCT, thus making it possible to quantify the change over time of the signal generated by static FFOCT.

Thus, by using these two branches, it is also possible to distinguish between morphological structures in a sample (such as collagen fibres, cells and their nuclei, etc.)—in this case by static imaging—and metabolic elements that make up a tissue of one of said structures in the same sample (such as the organelles of a cell, e.g. mitochondria) and/or the general metabolic state of one of these structures, in particular the cells and nuclei—in this case by dynamic imaging.

Full-field optical coherence tomography imaging is particularly advantageous for carrying out non-invasive imaging on a three-dimensional structure, enabling numerous different applications: studying organoids, modelling diseases, making cancer diagnoses, etc.

Specifically, both static FFOCT and D-FFOCT imaging make it possible to obtain a large amount of information on the functioning of living organisms owing to the specific features of its signal, all while being non-invasive and non-destructive.

More specifically, both static FFOCT and D-FFOCT imaging make it possible to obtain, in a spatially decorrelated manner, a local amplification of the signal backscattered within the sample (generally a three-dimensional volume) as well as associated local phase information, with a similar transverse resolution to that which can be obtained by confocal microscopy and a greater axial resolution than can be obtained by confocal microscopy. Thus, static FFOCT and D-FFOCT imaging are both sensitive to low-scatter objects and small longitudinal movements.

In addition, both static FFOCT and D-FFOCT imaging allow the presence of speckles to be greatly limited compared with analogue imaging techniques with phase resolution (interferential scattering microscopy, holographic microscopy, etc.). This enables direct interpretation of the object under study.

Moreover, static FFOCT and D-FFOCT imaging are both virtually insensitive to spatial aberrations, thus enabling imaging within three-dimensional structures.

Static FFOCT and D-FFOCT imaging thus both make it possible to detect small organs, such as subcellular constituents, within more complex three-dimensional structures such as tissues, even without markers.

In addition, in the specific context of D-FFOCT imaging, by analysing the obtained signals over time it is possible to highlight other contrasts: related, for example, to cellular activity (such as cellular activity of organelles, for example mitochondria, microvesicles, etc.).

However, with both static FFOCT and D-FFOCT imaging, when imaging under ex vivo or in vitro conditions with a view to imaging the sample strata closest to a face of the sample holder on which the sample is placed (the sample holder conventionally being a glass slide or plastics slide), optical interference artifacts occur. These artifacts, which are also sometimes referred to as interface artifacts or fringe artifacts, make studying the sample much more difficult or even render it entirely impossible.

This drawback is exacerbated in inverted microscopy (it should be noted that an inverted microscope is one in which a sample is viewed from below). It is also pointed out that a stratum is a two-dimensional section of the sample along a section plane in the body of the sample, i.e. along a section plane parallel to the face of the sample holder on which the sample is placed.

Consequently, both static FFOCT and D-FFOCT imaging are usually not used to image said strata close to said surface, in particular where very thin samples are being studied, such as samples of two-dimensional cell cultures. However, two-dimensional cell culture is still the most widely used in disease modelling and drug development, despite the emergence of three-dimensional cell culture. In addition, studying elements transitioning from a thin three-dimensional structure to a thicker three-dimensional structure is critical in certain applications, for example for studying intestinal organoids. However, static FFOCT and D-FFOCT imaging both appear to be post challenges for imaging the latter configuration.

### OBJECT OF THE INVENTION

The object of the invention is in particular to enable full-field optical coherence tomography microscopic imaging that reduces the occurrence of optical artifacts when imaging at least one sample.

### SUMMARY OF THE INVENTION

To this end, a method for the full-field optical coherence tomography microscopic imaging of at least one sample is provided, the method comprising the steps of:
emitting light that propagates in an object arm of an installation in which the sample is arranged such that the light is backscattered in the sample to produce an object wave,
generating at least one interference between the object wave and a reference wave.

According to the invention, the reference wave is generated by reflecting the light on a specular interface 10 arranged on the object arm.

The inventors have found that such a method made it possible to image the sample while avoiding optical artifacts as much as possible and even completely eliminating the optical artifacts that are present with the usual static FFOCT and D-FFOCT devices, in particular fringe artifacts.

This advantage is further enhanced when the aim is to image:
one of the strata of a thin sample (as indicated above, a stratum is a two-dimensional section of the sample along a section plane in the body of the sample, i.e. a section plane parallel to a face of the sample holder on which the sample is placed), the sample being for example a sample of a two-dimensional cell culture, a graphene sample, etc., and more generally a sample having a thickness of less than 15 micrometres, for example less than 10 micrometres, for example less than 5 micrometres;
one or more interface strata of a thicker sample (such as an organoid), i.e. the strata closest to a face of an element supporting the sample (glass slide, plastics slide, incubator, etc.).

The invention is based on the general principle of FFOCT imaging but enhances this principle by being self-referenced; the invention operates without a specific reference arm as in prior-art FFOCT devices, since the reference wave is generated from the specular interface, which is also expediently placed on the path of the object wave.

Furthermore, the specific position of the specular interface allows for automatic alignment between a reference field (linked to the reference wave) and an object field (linked to the object wave).

Interference is thus automatically obtained between the reference wave and the object wave.

This interference is also homogeneous.

Moreover, the interference is of very good quality since there are no optical aberrations.

The invention may furthermore be implemented by an installation having a simple structure.

In addition, the invention is thus less sensitive to vibrations than prior-art static and dynamic FFOCT devices because the reference waves and object waves propagate along the same object arm, meaning that the specular interface is at less of a distance from the sample (for example, the specular interface is between 0 and 15 micrometres away).

The invention can thus make it possible to create a uniform mosaic (a mosaic being an assembly of N acquired images of different areas of the same stratum of a given sample), that is to say without any overlapping artifacts between two images of the assembled mosaic.

In addition, the invention can be implemented in a miniaturised installation depending on the intended application. Among other things, the invention uses only one objective owing to the fact that it is self-referenced.

The invention can advantageously be implemented in noisy environments, for example on a vehicle (land, air, sea, etc.), a production line, etc.

The invention can furthermore be associated with:
technologically advanced elements in the field of imaging (which may or may not form part of the invention), for example an objective having a high numerical aperture (NA);
more basic elements in the field of imaging (which may or may not form part of the invention), for example a mobile phone:
   equipped with a camera to acquire images of the sample after interference of the waves, and/or
   equipped with a light (e.g. light-emitting diode (LED) and in particular a flash LED) as the light source, and/or
   equipped with a processing member (e.g. a processor) for processing the interference signal(s).

Optionally, the invention is also configured to perform dynamic full-field optical coherence tomography microscopic imaging.

For this purpose, the method comprises an additional step for studying the change over time of a resulting signal or of the interference(s) between the reference waves and the object waves.

The method makes it possible to perform both static FFOCT and D-FFOCT imaging.

The method is configured for performing time-domain optical coherence tomography microscopic imaging.

By way of example, the invention thus also makes it possible to look at morphological elements in a sample such as collagen fibres, cells and their nuclei, etc.—by static imaging—and metabolic elements that make up a tissue of one of said elements in the same sample (such as the organelles of a cell, e.g. mitochondria) and/or the general metabolic state of one of these elements, in particular the cells and nuclei—by dynamic imaging. The elements may, for example, be cells, structures and in particular subcellular structures such as nuclei, mitochondria, pigments, etc.

It should also be noted that the invention is less sensitive to vibrations than the prior-art static and dynamic FFOCT devices.

This aspect is particularly beneficial if the invention is used in a D-FFOCT imaging context.

Prior-art D-FFOCT imaging devices are difficult to use outside optical laboratories, whereas the invention can be implemented in challenging and/or noisy environments (a noisy environment being one affected by mechanical vibrations).

For the purposes of the present application, “object arm” means the part of the installation situated between the sample and an optical element for generating the interfaces, for example an optical beam splitter element (a light ray thus being able to propagate in said object arm along a given optical path).

Optionally, the specular interface is arranged so as to be at a given distance from a plane imaged by the installation, said distance being greater than or equal to zero and less than or equal to:
two times a depth of field of an installation objective intended for viewing the sample, or
two times a temporal coherence length of a light source generating the light if the coherence length is less than the depth of field of the objective.

“Imaged plane” (which may also be referred to as the “image plane”) means a plane that is imaged on an acquisition device (which may or may not form part of the invention), said device being suitable for acquiring at least one signal resulting from the interference between the reference waves and the object waves. The “imaged plane” therefore corresponds to one of the strata of the sample that is conjugated with the acquisition device.

The “depth of field of the objective” is defined by 2λ/NA² (where λ is the central wavelength of the light emitted by the source and NA is the numerical aperture of the objective).

The “temporal coherence length” L_{c} is defined as the half-height width of the autocorrelation function of the spectrum of the interference(s). For example, for a Gaussian distribution spectrum source, it is expressed as: L_{c}=\sqrt{2} ln 2λ²/πnΔλ (where n is the refractive index of the medium in which the sample is immersed).

The method is thus particularly effective for imaging strata at distances of zero to two times 2λ/NA² from the specular interface.

The invention also relates to an optical apparatus for the full-field optical coherence tomography microscopic imaging of at least one sample, the apparatus comprising an objective for viewing the sample during operation, the device comprising a specular interface, the device thus being capable, during operation, of allowing at least one interference to be produced between:
at least one reference wave obtained by reflecting light emitted by a light source associated with the apparatus on the specular interface and
at least one object wave obtained by backscattering the light emitted by said source onto the sample,

the specular interface being arranged with respect to the objective such that during operation the object wave passes through said specular interface as it travels between the sample and the source.

Optionally, the specular interface is arranged so as to be at a given distance from a plane imaged by the installation, said distance being greater than or equal to zero and less than or equal to:
two times a depth of field of the objective, or
two times a temporal coherence length of the light source if the temporal coherence length is less than the depth of field of the objective.

Optionally, the specular interface of the apparatus is a glass slide or a plastics slide.

Advantageously, the source is part of the apparatus.

Advantageously again, the apparatus comprises an acquisition device suitable for acquiring at least one signal resulting from the interference between the reference waves and the object waves.

The apparatus according to the invention can also be configured to enable dynamic full-field optical coherence tomography microscopic imaging.

The apparatus according to the invention may further comprise an incubator for receiving the sample.

Advantageously, the source of the apparatus illuminates a beam splitter element of the installation through an optical unit comprising at least one optic and at least one diaphragm.

Advantageously, the specular interface is part of the sample holder. Even more advantageously, the specular interface is a sample-holder face that faces the sample during operation.

The invention also relates to an installation comprising an apparatus as described above.

Optionally, the installation comprises a reference arm, the installation thus being capable, during operation, of also allowing at least one interference to be produced between:
at least one reference wave obtained by reflecting the light emitted by the light source on a reflection surface of the additional reference arm and
at least one object wave obtained by backscattering the light emitted by said source onto the sample,

the installation comprising means for locking the reference arm.

These means for locking the reference arm may be temporary.

At least part of the installation according to the invention may be integrated in a mobile phone.

Thus, when the sample is to be imaged, it is possible either to create interference using the specular interface (the locking means preventing the light paths to and from the reference arm) or to create interference using the reflection surface (the locking means then being inactive).

The installation thus makes it possible to benefit from two different technologies in an advantageous and simple way in order to optimally image a sample.

Optionally, the installation is configured to perform dynamic full-field optical coherence tomography microscopic imaging.

Thus, it is possible to implement both FFOCT and D-FFOCT imaging when the reference arm is used, in order to increase the imaging depth.

Due to its simple structure, the apparatus can advantageously be installed relatively simply in pre-existing static or dynamic FFOCT installations.

For the purposes of the present application, “reference arm” means the part of the installation located between the reflection surface and an optical element for generating the interfaces (a light ray thus being able to propagate in said reference arm along a given optical path).

For the purposes of the present application, “illumination arm” means the part of the installation located between the source and the optical element for generating the interfaces (a light ray thus being able to propagate in said object arm along a given optical path).

Other features and advantages of the invention will become clear on reading the following description of particular and non-limiting embodiments of the invention.

### BRIEF DESCRIPTION OF THE DRAWINGS

Reference is made to the accompanying drawings, in which:

FIG. 1 is a schematic view of an apparatus according to a first embodiment of the invention;

FIG. 2a is a schematic view of an apparatus according to a second embodiment of the invention when a reference arm of said apparatus is locked;

FIG. 2b is a schematic view of the apparatus shown in FIG. 2a when the reference arm is operational.

### DETAILED DESCRIPTION OF THE INVENTION

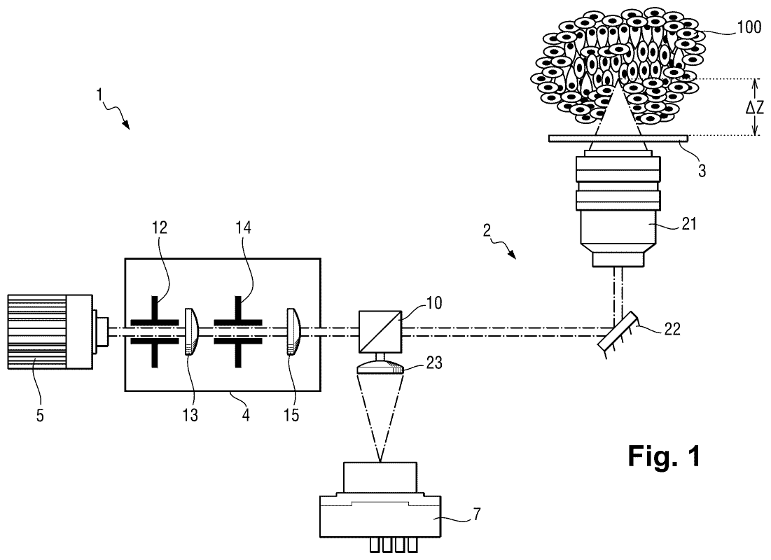

With reference to FIG. 1, the installation 1 according to a first embodiment of the invention is configured to perform static and dynamic full-field optical coherence tomography microscopic imaging, in particular in the region of one or more interface strata of a sample 100 (regardless of the thickness of the sample 100). The sample 100 is supported by a sample holder. By way of example, the sample holder is a glass slide, a plastics slide, an incubator, etc.

The installation 1 also comprises an optical apparatus 2 configured to allow the sample 100 to be viewed, in this case from below the sample 100.

The apparatus 2 further comprises a frame (not shown here) and a stage (not shown here) for supporting the sample holder together with the sample 100 to be viewed, the stage being movable in translation with respect to the frame along at least two translation axes.

The apparatus also comprises an interference device which in this case comprises a source 5 and a specular interface 3, the interference device thus being capable, during operation, of producing optical interference between:
reference waves obtained by reflecting the light emitted by the source 5 on the specular interface 3 and
object waves obtained by backscattering the light emitted by said source 5 onto the sample.

The source 5 is a “spatially incoherent” source.

The source 5 is, for example, a halogen lamp, a light-emitting diode (LED) or a unit formed by a spatially coherent source (the coherent source being a laser, for example) and a structure through which the rays pass at the output of the spatially coherent source, said structure allowing said rays to be made spatially incoherent at the output of the structure (and therefore of the unit). By way of example, the structure has a multimode-type cavity, a multimode fibre, a hexagonal rod, etc.

The source 5 here is a temporally incoherent source or a source having a short temporal coherence length (e.g. in a range of 0.5 to 15 micrometres, preferably 1 to 10 micrometres). It is thus understood that even if the source 5 is “temporally incoherent”, it is still possible to define a coherence length for it (although this length will be small).

Here, the installation also comprises an acquisition device 7. In the present case, the acquisition device 7 is part of the apparatus. The acquisition device 7 makes it possible to acquire at least one signal resulting from the interference between the reference waves and the object waves.

For this purpose, the acquisition device 7 comprises an optical sensor. The optical sensor is preferably a complementary metal-oxide-semiconductor (CMOS) optical sensor.

Preferably, the optical sensor is selected to acquire images at a high rate. This makes it possible, if so desired, to follow a series of movements within the sample when the sample comprises at least one live cell. For example, the optical sensor is capable of acquiring images at a frequency greater than 100 Hertz, preferably greater than 200 Hertz, preferably greater than 400 Hertz.

Preferably, the optical sensor is selected to acquire raw images (i.e. at the input of the acquisition device) at a high signal-to-noise ratio. This allows the optical sensor to be sensitive even to very small structures in the living organism and/or to even very small movements. For example, the optical sensor is capable of acquiring raw images at a signal-to-noise ratio greater than 500, preferably greater than 800, preferably greater than 1000.

By way of example, the optical sensor is a camera, for example a full-well capacity camera, for example a CMOS camera, for example a Q-2A750 camera or a Q-2HFW camera, both sold by Adimec.

In this case, the assembly 1 also comprises a device (not shown here) for processing the signal emitted by the acquisition device 7 in order, for example, to generate an image of at least part of the sample. In the present case, the signal processing device is external to the apparatus 2. The signal processing device comprises at least one processing unit such as a processor. By way of example, the signal processing device comprises a computer.

Preferably, the installation 1 comprises a microscope incubator (not shown here), which then forms the sample holder of the sample 100. By way of example, the incubator 1 is arranged in the apparatus 2 so as to be supported by the stage, the sample 100 being placed directly in the incubator.

The incubator is preferably portable so that it can be temporarily mounted in the apparatus 2.

The incubator allows samples comprising at least one live cell to be studied in a more straightforward manner. Specifically, the incubator allows such samples to be kept alive over several days or even several weeks.

Preferably, the incubator is shaped so as to be able to receive multi-well plates.

Preferably, the incubator is provided with a temperature control within the incubator.

This makes it possible, for example, to prevent the sample 100 heating up, which could alter or destroy the sample 100.

Preferably, the incubator is equipped with a control for the presence of at least one gas in the incubator. For example, the incubator is provided with a control for the presence of carbon dioxide in the incubator and/or for the presence of nitrogen in the incubator and/or for the presence of oxygen in the incubator.

Where the sample comprises live cells, the incubator is preferably configured to keep the sample 100 at a given temperature, for example at a temperature substantially equal to 37 °C (for example for human, primate or pig cells, etc.). Preferably, the incubator is configured to allow the sample to be oxygenated (in particular by supplying a nitrogen-oxygen mixture and evacuating the carbon dioxide), this oxygenation being ensured at least by controlling the level of carbon dioxide in the incubator. Preferably, the incubator is configured to allow the humidity level of the sample to be managed so that the sample does not dry out. For example, the incubator is equipped with a sensor for checking that the humidity level in the incubator 9 is between 70 and 100%.

In this case, the incubator is advantageously a conventional incubator. For example, the incubator is an H201-K incubator sold by Okolab.

The interference device will now be described.

The interference device comprises a seat that is immovable relative to the frame.

Said seat supports a beam splitter element 10, which in this case is a non-polarising beam splitter (NPBS) element 10. By way of example, the splitter element 10 may be a non-polarising splitter cube, a non-polarising splitter plate, etc.

The source 5 is intended for illuminating the splitter element 10 by means of an optical unit 4.

In the present case, both the optical unit 4 and the source 5 are arranged in line with the splitter element 10. Here, the optical unit 4 and the source 5 are supported by the seat and are thus immovable with respect to the splitter element 10 and therefore with respect to the frame.

Inside a housing of the optical unit, which is the part of the optical unit 4 fastened to the seat, the optical unit 4 comprises, one after the other between the source 5 and the splitter element 10:
a first diaphragm 12 arranged downstream of the source 5,
a first optic 13 (for example a single lens, a single doublet or a pair of lenses or a pair of doublets) arranged downstream of the first diaphragm 12,
a second diaphragm 14 arranged downstream of the first optic 13,
a second optic 15 (for example a single lens, a single doublet or a pair of lenses or a pair of doublets) arranged downstream of the second diaphragm 14 and upstream of the splitter element 10.

The four aforementioned elements are fixed in place in the housing and are thus immovable with respect to the splitter element 10 and therefore with respect to the frame.

By way of example, the first optic 13 allows the divergence of the rays generated by the source 5 to be reduced. This limits any loss of power in the light radiation generated by the source 5.

By way of example, the first diaphragm 12 is an aperture diaphragm. The first diaphragm 12 is arranged in a focal plane of the first optic 13, preferably in the image focal plane of the first optic 13. Thus, the first optic 13 images the source 5 at the image focal plane of the first optic 13, which coincides with the first diaphragm 12. It is noted that the source 5 is conjugated with the first diaphragm 12 by means of the first optic 13. Therefore, by way of its aperture, the first diaphragm 12 makes it possible, for example, to control the degree of spatial incoherence of the source 5 and/or the amount of light received by the sample 100 and/or the illumination numerical aperture of the installation 1. Moreover, the first diaphragm 12 is arranged in a focal plane of the second optic 15, preferably in the object focal plane of the second optic 15. Furthermore, the focal length of the second optic 15 must be less than or equal to the distance between the first optic 13 and the first diaphragm 12.

By way of example, the second diaphragm 14 is a field diaphragm. The second diaphragm 14 makes it possible to restrict the illumination of the sample so as to illuminate only the portion of the sample that will be imaged by the installation 1 and/or to reduce incoherent reflections. The second diaphragm 14 is arranged in a focal plane of the second optic 15, preferably in the object focal plane of the second optic 15.

For the purposes of the present application, “upstream” and “downstream” should be understood according to the direction in which the light flows.

For the purposes the present description, “diaphragm” means any member for controlling the passage of the light radiation generated by the source 5: an iris diaphragm, a hole in a dedicated wall, etc.

In the example shown, the source 5, the first diaphragm 12, the first optic 13, the second optic 15 and the second diaphragm 14 are thus located one after the other upstream of the splitter element 10.

As already mentioned, the first optic 13, the first diaphragm 12, the second optic 15 and the second diaphragm 14 are fixed in place in the apparatus.

The source 5 therefore illuminates the splitter element 10 (via the optical unit), thereby allowing an “illumination arm” of said splitter element 10 to be defined.

Furthermore, the splitter element 10, once it has been illuminated by the source, allows an arm referred to as an “object arm” to be formed, which is associated with the sample during operation. The source 5 is not on the object arm but on the illumination arm.

Furthermore, the installation 1 comprises a first objective 21 associated with the object arm.

Preferably, the numerical aperture of the first objective 21 is high. For the purposes of the present application, “high” means a numerical aperture greater than 0.8, preferably greater than 1, preferably greater than 1.4.

It is noted that the second optic 15 allows the source 5 to be imaged on the focal plane of the objective, for example on the object focal plane of the objective.

The first objective 21 is part of the apparatus 2, for example.

The sample 100 (or at least the stratum of the sample 100 that is to be imaged) is intended to be positioned at one of the foci of the first objective 21, for example at the secondary focus of the first objective 21.

Consequently, the first objective 21 is on the object arm.

Preferably, the second diaphragm 14 is arranged in a focal plane of the second optic 15, for example in the object focal plane of the second optic 15. Thus, the second diaphragm 14 is conjugated with the sample by means of the first objective 21 (the sample being at a focus of the first objective 21, for example at the secondary focus of the first objective 21). Furthermore, the source 5 is conjugated with a focus of the first objective, for example the primary focus (pupil plane) of the first objective 21 (by means of the first optic 13).

Since the apparatus here is of the inverted type, the first objective 21 is arranged so as to view the sample 100 from below the sample 100. By way of example, the first objective 21 is arranged under the stage and, in the present case, under the incubator.

The apparatus 2 comprises a reflection surface 22 such that a ray passing through the first objective 21 along the optical axis of said first objective 21 can be reflected as far as the splitter element 10. This allows the first objective to be vertical.

Typically, the reflection surface 22 is planar. For example, the reflection surface 22 is a mirror, for example a thick mirror, for example a mirror having a thickness greater than or equal to 3 millimetres, for example a thickness greater than or equal to 4 millimetres. Preferably, said reflection surface 22 is a planar mirror supported by a prism or a planar mirror supported by a cube.

In the present case, said reflection surface 22 is arranged such that a ray propagating along the optical axis of the first objective 21 is then propagated, after being reflected on the reflection surface 22, to then propagate along the object arm as far as the splitter element 10.

The interference device also comprises the above-described specular interface 3 arranged between the first objective 21 and, in this case, the sample 100.

The specular interface 3 is part of a glass slide, for example. By way of example, the specular interface 3 is part of the sample holder supporting the sample 100.

Preferably, the specular interface 3 is movable relative to the first objective 21 and thus movable in the frame.

To this end, the specular interface 3 is associated with at least one member for moving the specular interface 3 relative to the frame, in particular relative to the first objective 21 (in particular for moving the specular interface 3 towards or away from the objective 21). By way of example, the specular interface 3 is supported by an underframe that is moved by means of the movement member. For example, the movement member is configured to move the specular interface in at least one translation. For example, the movement member is configured to move the specular interface 3 in at least one translation along the optical axis of the first objective 21.

Preferably, the stage and the specular interface 3 are immovable relative to each other. In this case, therefore, the stage is linked in translation to the specular interface 3; for this purpose, the stage is fastened to the underframe, to which the specular interface is also fastened. Consequently, when the specular interface is moved towards or away from the first objective 21, the stage (and therefore the sample) is also moved towards or away from the first objective 21 in the same way.

Furthermore, the specular interface 3 is arranged in the apparatus 2 such that the distance between the specular interface and the plane imaged by the installation is in this case between zero and three or more times (inclusive) the depth of field of the first objective 21, preferably between zero and two times (inclusive) the depth of field of the first objective 21, preferably here between zero and one times (inclusive) the depth of field of the first objective 21.

For this purpose, it is advantageously possible, if necessary, to move the assembly composed of the stage and specular interface 3 relative to the first objective 21 in order to fulfil this function.

In a specific case, the imaged plane is the image focal plane of the first objective 21. The imaged plane may, however, be different from said image focal plane depending on the relative position of the acquisition device 7 in the installation 1.

Since in this case the stratum, which is to be imaged, of the sample 100 is located in the image focal plane of the first objective 21, it is therefore ensured that the distance between said stratum and the specular interface 3 is preferably less than or equal to two times the depth of field. Preferably, it is therefore ensured that the distance between said stratum and the specular interface 3 is less than one times the depth of field of the first objective 21.

This allows the specular interface 3 to serve as a reference field for the reference waves.

Where the source 5 emits light rays according to a spectral distribution in accordance with a Gaussian law, λ₀ can be defined as the central wavelength of said distribution and Δλ can be defined as the spectral width of said definition.

Under such circumstances, the first objective 21 and the specular interface 3 are arranged such that the distance ΔZ between the image focal plane of the first objective 21 and the face of the specular interface 3 facing the sample 100 is preferably less than two times the depth of field of the first objective 21, i.e. less than two times 2λ₀/NA², where NA is the aperture field of the first objective 21.

It should be noted that where the depth of field is greater than the coherence length L_{c} of the central wavelength of the light source 5, then the distance ΔZ is preferably taken to be less than two times said coherence length L_{c}. As a reminder, L_{c} equals:

$${L}_{c} = \sqrt{2} \cdot ln 2 \cdot \frac{{λ}_{0}^{2}}{π n \cdot {Δλ}_{0}}$$

ΔZ is between 0 and 5 micrometres, for example. This value range is not limiting and will depend mainly on the properties of the first objective 21. In reality ΔZ is related to the maximum wavelength emitted by the light source 5 for which it is still possible to form interferences.

With this configuration, therefore, it is understood that the following are located one after the other on the object arm between the splitter element 10 and the sample 100: the reflection surface 22, the first objective 21 and the specular interface 3.

Thus, the specular interface 3 is on the object arm. It is therefore understood that the specular interface 3 has to be sufficiently transparent to let the light rays pass through so that they can reach the sample 100 and leave via the source 5.

Furthermore, it should be noted that the specular interface 3 is the element of the apparatus 2 that allows the reference waves to be obtained. However, the specular interface 3 is expediently arranged on the object arm.

Therefore, the apparatus 2 thus described does not need a dedicated reference arm since the expediently positioned specular interface 3 is used.

In addition, the apparatus 2 comprises a third optic 23 arranged at the output of the interference device, i.e. arranged between the splitter element 10 and the acquisition device 7. The third optic 23 may be part of the interference device or may not be part of said interference device.

By way of example, the third optic 23 is a single lens, a single doublet or a pair of lenses or a pair of doublets.

The acquisition device 7 is arranged in the focal plane of the third optic 23, for example in the object focal plane of the third optic 23.

In the present case, the optical axis of the acquisition device 7 is perpendicular to the illumination arm.

The installation 1 thus described is an improvement to a Linnik interferometer in a Koehler illumination configuration.

Starting from the described assembly 1, it is possible to perform both static full-field optical coherence tomography imaging and dynamic full-field optical coherence tomography imaging.

In the case of dynamic full-field optical coherence tomography imaging, a sample is placed in the apparatus 2 and a time sequence of N two-dimensional interferometric signals from a stratum of the sample 100 is acquired by the acquisition device 7.

Furthermore, the installation 1 thus described makes it possible in particular (though not exclusively) to image the closest stratum or strata of the sample 100 to the specular interface 3.

In addition, it is possible to perform full-field optical coherence tomography imaging either with the incubator or without the incubator.

Consequently, the installation 1 thus described allows numerous imaging possibilities to be implemented.

Owing to the described installation 1, it is possible, for example, to acquire images of cells but also to visualise cell activity and discern the metabolic state of a cell. The cells can, for example, be two-dimensional cultures such three-dimensional as two-dimensional monolayer cultures, cultures such as organoids, or other three-dimensional multilayer cultures, etc.

Specifically, it is possible to study the cells invasively but non-destructively.

One of the strengths of the described installation 1 is therefore its ability to create images without disturbing the natural environment. The installation 1 thus described can be used, for example, to study organoids, two-dimensional monolayer cultures, three-dimensional multilayer cultures, fibroblasts, retinas and corneas, retina and cornea explants from mice, pigs, macaques, etc., to perform quality control on large-scale organoid production, to assist with the fields of microfluidics and disease modelling, to test the efficacy of new treatments (genetics, pharmaceuticals, etc.), for transplants, etc.

Furthermore, the described installation 1 makes it possible to generate both a static signal for visualising the three-dimensional structure of a tissue, and a dynamic signal for identifying the cells of a tissue and measuring their metabolism, for example.

Other applications of the described installation 1 may be envisaged, for example all microscopy studies with high spatial resolution (for example a resolution between 100 and 400 nanometres) and/or temporal resolution (for example a resolution the millisecond range, for example 2 milliseconds), in particular those in which the sample is not destroyed and/or the absence of endogenous markers is incorporated.

In addition, it is possible to create real-time tracking of a sample by, for example, generating an image having a contrast that reflects movement mechanisms of around X milliseconds, X being between 100 and 200 milliseconds, X being 160 milliseconds, for example.

In addition, the installation 1 has smaller dimensions because it does not have a reference arm (in particular because it does not have a second objective arranged on the reference arm). The installation 1 can thus be miniaturised.

Furthermore, the described installation 1 has a simple structure and is therefore easy to implement even using means other than those mentioned above.

According to a first option, the acquisition device 7 may be a simple mobile phone equipped with a camera, for example a smartphone. In that case, the acquisition device 7 is not part of the installation 1. The installation 1 could, for example, comprise a station (optionally arranged on the frame of the apparatus), and even inexperienced users would be able to place their phone in the station provided for this purpose in order to carry out high-quality imaging in a simple and rapid manner.

It should be noted that the third optic 23 may optionally also be part of the mobile phone.

The installation 1 has smaller dimensions because it does not have a reference arm. The installation 1 can thus be miniaturised.

Optionally again, the light source 5 can also be part of the mobile phone.

Optionally again, the processing device can also be part of the mobile phone.

According to a second option, which can optionally be combined with the first option mentioned above, the installation 1 and/or the apparatus 2 is/are produced starting from an existing microscope. For example, the stage, the frame, the reflection surface 3 and the first objective 21 are those of an existing microscope, such as an inverted microscope. For example, the inverted microscope is a turret microscope.

However, said microscope is modified such that:
the specular interface 3 (and optionally its associated movement member) is arranged between the first objective 21 and the stage,
the interference device is added to the microscope, potentially along with the source 5 and the acquisition device 7,
the distance between the specular interface 3 and the first objective 21 is adjusted as indicated above.

This advantageously makes it possible to reduce the costs of constructing the installation 1.

In addition, it makes the installation 1 easier to use for any user already used to working with microscopes.

In addition, this makes it possible to benefit from the advantages of a conventional microscope such as the special imaging features (visible light imaging, fluorescence imaging, etc.), special objectives, etc. In particular, the microscope may be a microscope for which other optical modules have already developed, for instance been differential interference contrast modules (DIC), coherent anti-Stokes Raman scattering modules (CARS), second harmonic generation modules (SHG), third harmonic generation modules (THG), Raman modules, single-photon or two-photon fluorescence modules, etc.

With this second option, the installation 1 can thus be coupled to these prior-art modules in a simple manner, making it possible to expand the possibilities for imaging the sample 100. Furthermore, the associated microscope may be a microscope for which accessories have already been developed such that by starting from a microscope of this kind, the installation makes it possible to benefit from the accessories of the microscope. The aforementioned incubator may be a prior-art accessory of this kind, for example.

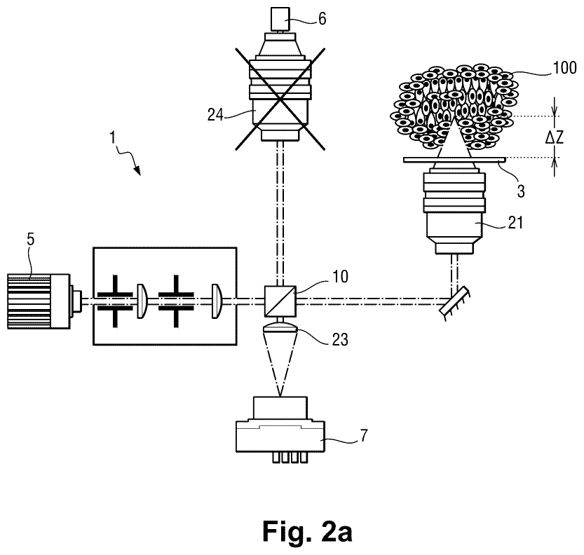

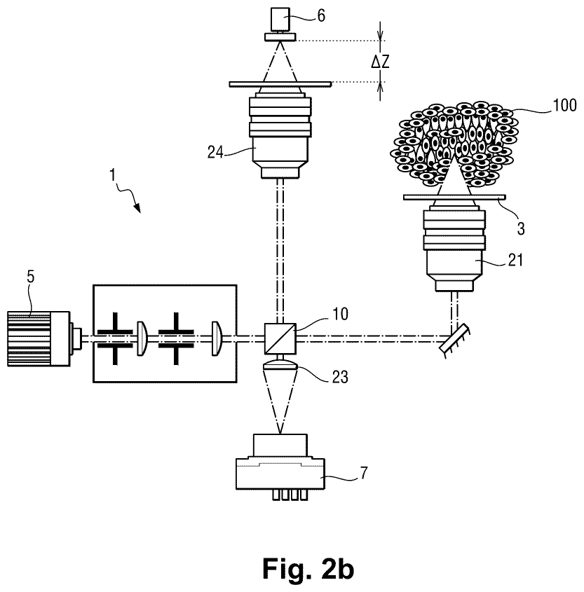

A second embodiment will now be described with reference to FIGS. 2a and 2b.

Whereas in the first embodiment the installation 1 did not have an additional physical reference arm (the specular interface 3 being supported by the object arm), in the second embodiment the installation 1 also comprises an additional physical reference arm. The entire installation described according to the first embodiment is therefore also present here.

With the additional reference arm, the interference device is thus also capable, during operation, of producing optical interference between:
reference waves obtained by reflecting the light emitted by the source 5 on a reflection surface 6 of the additional object arm and
object waves obtained by backscattering the light emitted by said source 5 onto the sample.

The reflection surface 6 is planar. The reflection surface 6 is a mirror, for example.

Furthermore, the installation comprises a second objective 24. The two objectives 21, 24 are identical and are each associated with one of the arms. Both objectives 21, 24 have the same numerical aperture (NA).

Optionally, the numerical aperture of the second objective 24 is high. For the purposes of the present application, “high” means a numerical aperture greater than 0.8, preferably greater than 1.

It is noted that the second optic 15 allows the source 5 to be imaged on a focal plane of the two objectives, for example on the object focal plane of the two objectives 21, 24.

The second objective 24 is part of the interference device. Thus, the second objective 24 is arranged in the region of the reflection surface 6. By way of example, the optical axis of the second objective 24 is normal to a plane in which the reflection surface 6 extends.

More precisely, in this case, the second objective 24 is arranged such that the reflection surface 6 is located in one of the foci of the second objective 24, for example at the secondary focus of the second objective 24.

The second objective 24 is therefore on the reference arm.

In the example shown, the second objective 24 and the reflection surface 6 are thus located one after the other downstream of the splitter element 10, on the reference arm side.

In the present case, the acquisition device 7, the third objective 23, the interface element 10, the second objective 24 and the reflection surface 6 are in line with one another.

Preferably, the reflection surface 6 can be moved in translation along the optical axis of the second objective 24.

For this purpose, the reflection surface 6 is mounted in the interference device so as to be movable relative to the frame so that it can be moved relative to the second objective 24. For example, the reflection surface 6 is mounted on a base that can be moved in translation relative to the frame. For example, the base can be moved in translation relative to the frame by means of at least one piezoelectric actuator.

In addition, the reference arm is associated with means (not visible here) for locking said reference arm in order to temporarily prevent light rays from moving along the reference arm. For example, a cover, a shutter or a mirror can be temporarily arranged in the region of the splitter element 10, or the splitter element 10 can be oriented differently, or the reference arm is mounted on a seat that can be moved relative to the splitter element 10, etc.

Thus, according to a first use option for the installation shown in FIG. 2a, the sample 100 can be imaged in the same way as in the first embodiment without having to use the reference arm. The locking means are thus activated to prevent light rays from moving along the reference arm.

In this configuration, the distance ΔZ is defined between the imaged plane and the specular interface 3. This distance is preferably less than two times the depth of field of the first objective 21 (or equal to two times the coherence length of the central wavelength of the source 5 if the depth of field of the first objective is greater than said coherence length).

Preferably, this option is primarily used to image the interface stratum/strata of the sample 100 or to image two-dimensional samples 100.

According to a second use option for the installation shown in FIG. 2b, the sample 100 can be imaged in the more conventional way by using the reference arm. The locking means are thus deactivated to allow the light rays to move along the reference arm.

By way of example, the specular interface 3 remains in place in the installation 1, this feature being taken into account when adjusting the reference arm.

In this configuration, the distance ΔZ is defined between the imaged plane and the reflection surface 6. By way of example, the imaged plane corresponds to the image focal plane of the second objective 24 (but the imaged plane could correspond to another plane depending on the position of the acquisition device 7 in the installation).

This distance ΔZ is preferably less than at least two times the depth of field of the second objective 24 (or two times the coherence length of the source if the coherence length of the source is less than the depth of field of the second objective).

This option is preferably used primarily to image the sample 100 in the furthest strata from the first objective.

Advantageously, it is thus possible to easily switch from a first use option to a second, thereby further expanding the possibilities for imaging the sample 100.

It should be noted in particular that for both the first and the second use option, it is thus possible to carry out both FFOCT and D-FFOCT imaging, regardless of whether the first or the second use option is selected.

It should be noted that the above-mentioned first and second options for the first embodiment are also applicable to this second embodiment.

It goes without saying that the invention is not limited to the described embodiments but covers any variant falling under the scope of the invention as defined by the claims.

In particular, the incubator may or may not be part of the installation and/or the acquisition device may or may not be part of the installation and/or the processing device may or may not be part of the installation and/or the source may or may not be part of the installation and/or the mobile phone may or may not be part of the installation.

In addition, the acquisition device may or may not be part of the apparatus and/or the processing device may or may not be part of the apparatus and/or the source may or may not be part of the apparatus.

The apparatus might not be inverted. The sample could thus be illuminated from above (in which case the first objective also picks up the signal from above) as well as from below (in which case the first objective preferably also picks up the signal from below).

The optical sensor could be different from that specified; for example, the optical sensor could be a charge-coupled device (CCD) sensor. The optical sensor could be capable of working in the visible range and/or in another range, such as infrared. The optical sensor could thus be a near-infrared image sensor (or a short-wave-infrared sensor, SWIR). By way of example, the optical sensor could be an InGaAs (indium gallium arsenide) sensor or an InGaAs SWIR sensor. The apparatus and/or the installation could be shaped such that the optical sensor (and/or the acquisition device) is interchangeable in order, for example, to be able to work in the visible range and then to be able to work in a range other than the visible range, for example infrared.

The installation might not comprise an incubator (whether portable or not). The installation could comprise a heating chamber in which at least the microscope is arranged so as to be able, for example, to keep the sample at a given temperature.

Although high-numerical-aperture objectives have been used here, objectives having a lower numerical aperture could of course also be used.

The microscope might not have a turret.

The apparatus might not have a reflection surface arranged on the object arm as described above.

The first objective could be aligned with the source.

The specular interface could comprise a particular surface treatment for modifying its reflection coefficient.

The specular interface may be able to be temporarily removed from the apparatus, or it could be fastened without any option to disassemble the apparatus.

Although here it is the specular interface that moves with respect to the first objective, it could be the first objective that moves with respect to said specular interface. Alternatively, the first lens and the specular interface could be at a fixed distance from each other in the frame.

Although here the specular interface is a glass slide, the specular interface could be a slide made of another material, for example a plastics slide. The specular interface could be an element made of glass, plastics material or any other material that lets light rays pass through, the material preferably being planar and/or smooth. The specular interface could be part of a slide or be part of another differently shaped element, for example in the form of a plate or any other shape that lets the light rays pass through said specular interface.

The specular interface may or may not be integrated in the sample holder, in particular when said sample holder is a slide (made of glass, plastics material, etc.). Although here the specular interface is distinct from the stage, the specular interface could be integrated in the stage.

Although here the specular interface is the slide face that faces the sample, the specular interface could be the slide face that faces the first objective or any other layer within the slide. For one and the same sample, it would alternatively also be possible to consider the specular interface formed by the face that faces the first objective and the specular interface formed by the face that faces the sample, thereby allowing at least two different strata of said sample to be imaged (an interface stratum and a stratum spaced apart from said interface stratum by a distance equal to the distance between the two interfaces).

Although here the beam splitter element is non-polarising, the beam splitter element could be polarising and be associated with an additional piece of equipment providing the non-polarisation (e.g. retardation plates such as quarter-wave plates). The beam splitter element could thus be any splitter element, such as a non-polarising beam splitter element (NPBS), a polarising beam splitter element, a beam splitter element of the “Polka dot” type, one or more membranes, etc.

The reflection surface 22 could be omitted in the installation.

Although here the specular interface remains in place in the second configuration, in a variant the specular interface could be temporarily removed from the installation for as long as the second configuration is selected.

1-14. (canceled)

15. An installation comprising an optical apparatus for the full-field optical coherence tomography microscopic imaging of at least one sample, the apparatus comprising an objective for viewing the sample during operation, the installation comprising a specular interface, the installation thus being capable, during operation, of allowing at least one interference to be produced between:
at least one reference wave obtained by reflecting light emitted by a light source associable with the apparatus on the specular interface and
at least one object wave obtained by backscattering the light emitted by said source onto the sample,
the specular interface being arranged with respect to the objective such that during operation the object wave passes through said specular interface as it travels between the sample and the objective,
the apparatus comprising an acquisition device suitable for acquiring at least one signal resulting from the interference between the reference waves and the object waves, said signal being dedicated to be processed by a device to process, in order to generate an image of at least part of the sample,
wherein the specular interface and the objective are movable in relation to each other in at least one translation along the optical axis of the objective.

16. The installation according to claim 15, wherein the specular interface is a glass slide or a plastics slide.

17. The installation according to claim 15, wherein the source is part of the apparatus.

18. The installation according to claim 15, wherein the apparatus is also configured to enable static and dynamic full-field optical coherence tomography microscopic imaging.

19. The installation according to claim 15, comprising an incubator for receiving the sample.

20. The installation according to claim 15, wherein the source illuminates a beam splitter element of the installation through an optical unit of the installation comprising at least one optic and at least one diaphragm.

21. The installation according to claim 15, comprising a sample holder wherein the specular interface is part of the sample holder.

22. The installation according to claim 21, wherein the specular interface is a sample-holder face that faces the sample during operation.

23. The installation according to claim 15, the installation comprising an additional reference arm, the installation thus being capable, during operation, of also allowing at least one interference to be produced between:
at least one reference wave obtained by reflecting the light emitted by the light source on a reflection surface of the additional reference arm and
at least one object wave obtained by backscattering the light emitted by said source onto the sample.

24. The installation according to claim 15, comprising temporary means for locking the additional reference arm.

25. The installation according to claim 15, wherein at least part of the installation is integrated in a mobile phone which belongs to the installation.
